(19) United States
(12) Patent Application Publication
(10) Pub. No.: US 2019/0259248 A1
(43) Pub. Date: Aug. 22, 2019

(54) Hot Links

(71) Applicant: Eric Johnson, Midlothian, VA (US)

(72) Inventor: Eric Johnson, Midlothian, VA (US)

(21) Appl. No.: 15/980,775

(22) Filed: May 16, 2018

Related U.S. Application Data
(60) Provisional application No. 62/710,680, filed on Feb. 22, 2018.

(51) Int. Cl. G07F 17/32; A63F 1/06; G06Q 50/34

(52) U.S. Cl. CPC G07F 17/3293; G06Q 50/34; A63F 1/06; G07F 17/3244

(57) ABSTRACT

The invention relates to a casino game for live play and play through an electronic device and including methods for playing the casino game. The casino game includes a deck of cards having at least two series of cards having values 1-n wherein n is any whole number; and at least two colors, wherein each series of the at least two series of cards consists of cards having the same color. The game also includes Ante wagers and Bonus wagers each having separate win conditions and payout odds.

This application claims the benefit of the filing date of U.S. Provisional Application Ser. No. 62/710,680 filed Feb. 22, 2018, which is incorporated by reference herein.

### BACKGROUND OF THE INVENTION:

Gamblers enjoy side betting in games to double the opportunity of winning and just to have another opportunity to gamble. But there is also a need to preserve the integrity of the game being played to maintain the original unadulterated use of cards and play so that the original card game is not altered by the optional side betting game and that players can play the original casino card game without the optional side betting if they choose. Prior art casino card games related to Hot Links game, which provide a number of community cards dealt face down on a playing table to be combined with cards dealt to each player often are directed to traditional poker hand quality determinations. Games like three card poker can offer altered poker hand quality determinations based the player being provided a smaller number of cards.

Some casino games also offer side bets which allow for increased payouts it certain low probability card combinations are obtained by the player or in some instances dealt to the player, for example, a full house or royal flush.

Poker games played against other players and/or against a dealer hand add a level of difficulty and human judgment which complicates winning rather than just winning on the value of the cards themselves against a payout table. The payout table game provides a faster game and more certainty on the part of the player that a hand will pay off, even if the player lacks competitive play skill, and also does not depend upon how good or how bad the hands of the other players or the dealer may be.

U.S. Pat. No. 9,564,016 is directed to a game call criss cross poker which is includes both vertical and horizontal axis community cards which share a common center. Players can wager on both the vertical axis community cards and the horizontal axis community cards. The patent also includes the following prior art citations:

U.S. Patent Application #US20120149451, published Jun. 14, 2012 by Nicely et al, discloses a gaming device which provides a single player poker game including one or more opportunities for forming player hands. In one embodiment, for a play of the poker game, a player places a wager on each of a plurality of player hands. The gaming device provides the player with one or more opportunities to fold one or more of the player hands and withdraw the wager associated with the folded hand. A number of community cards are dealt. The gaining device determines and provides any awards associated with a ranking of each of the remaining player hands according to a paytable.

U.S. Patent No. 62/048,267, indicates a multiple hand stud poker game wherein a player wagers on one or multiple hands and using a single standard fifty-two card deck of playing cards. Three cards are dealt face up to each of the player hands. Two cards are then dealt—one face up and one face down—to be used as cards that can be selected by the player for use in the player's hand. The player selects either the face up card or the face down card. The selected card is added to the player's first hand and is displayed face up. The unselected card is then discarded. Two more cards are dealt—one card face up and one card face down. The player again selects either the face up card or the face down card. The selected card is added to the player's second hand and is displayed face up with the unselected card being discarded. Two more cards are dealt—one card face up and one card face down. The player again selects either the face up card or the face down card. The selected card is added to the player's third hand and is displayed face up with the unselected card being discarded. The same procedure is used to add a fifth card to each of the player's hands. This results in the player having three complete five card hands. The amount won by the player is based on the amount wagered by the player and the poker ranking of the player's hand based on a payout schedule.

U.S. Pat. No. 6,042,118 issued to Poitra, describes a method of playing a poker-type game wherein the game provides the players an opportunity to increase the amount wagered based upon two of three community cards shown. After each player places a bet, two cards are dealt face down to each player and three cards are dealt face down to the dealer that are “community cards”. The dealer then turns over two of the three community cards so that they are facing up. Each player has the opportunity to “double-down”. The dealer then turns over the remaining community card and then turns over each player's two cards. The bets are resolved by using the three community cards in combination with each player's two cards based upon a predetermined plurality of winning card combinations similar to poker. The card deck is a standard 52 card deck with one joker to make a 53 card deck. The joker is utilized only in certain combinations as a ‘wild card.

U.S. Patent Applications #US20050242506, published Nov. 3, 2005 and #US20120225706, published Sep. 6, 2012 both Mississippi Stud variations by Yoseloff, claim a card game played against a pay table. Wherein the player receives a partial hand that is preferably completed by community cards (but may be completed by cards dealt directly to a hand or a combination of cards dealt directly to a hand and at least one community card or Wild card). After placement of an Ante Wager, each player Will have an opportunity to place a game Wager before receiving another card for the player's hand (Whether dealt directly to the player or as a community card revealed to all players). At least some or all game Wagers may be an amount within a range of multiples of the player (such as 1×, 2×, 3× 4× or 5× the amount of the Ante Wager). The range of Wagers may remain the same or vary with the number of dealt cards or community card revealed to the players.

U.S. Pat. Nos. 5,489,101 and 5,531,448, issued to Moody, describe poker games in which a player attempts to form a five card poker hand that has the highest poker hand ranking. In the house banked version, all players play against the house and not against each other. The game is played with a standard fifty-two card deck. The game is played by a dealer and from one to seven players. Each player makes a bet and a portion of each bet may be allocated to a progressive jackpot. The dealer deals five cards to each player. The dealer then deals six cards as the community cards which are arranged face down in three rows in a triangle pattern on the gaming table layout. The players may discard from none to five unwAnted cards. The dealer turns up the community cards and pre-designated groups of cards from the community cards are used for each player to make a complete five card poker hand. The dealer determines the best hand each player has made according to poker hand rankings. All winning hands will be paid by the dealer according to the odds listed in the pay table. When the progressive jackpot payout is used, the dealer examines the six community cards to determine if one of the predetermined card arrangements has occurred. Any winning payouts from the progressive jackpot are distributed to the players at the table. The method may also be played as a player banked game or as a pot game. In one version of the present invention, the dealer deals three cards to each player. The dealer then deals eight cards as the community cards which are arranged in groups or pairs of two cards each on the gaming table layout. In the preferred embodiment of the present invention, the card layout is in the format of a directional compass with a pair of cards each at the North position, East position. South position and West position, respectively.

U.S. Pat. No. 5,657,993, issued to Merlino, describes a method of playing a poker-type wagering game on top of a table layout having first and second player locations, a plurality of betting areas associated with each of the player locations and a community card area. The method includes a first player placing a wager on top of each of the betting areas associated with the first player location. A second player places a wager on top of each of the betting areas associated with the second player location. Each player receives two playing cards. A number of community cards are dealt face down in the community card area in a predetermined pattern. The number of community cards corresponds to the number of betting areas in one of the player locations. The faces of community cards are exposed in succession. Each time a community card is exposed, each of the players can either fold wherein the folding player loses a number of wagers which corresponds to the number of community cards exposed or the players can leave all of the wagers on the corresponding betting areas until all of community cards are exposed. Once all of the community cards are exposed, each of the players combines his or her pair of cards with three of the community cards to form a completed stud poker hand. The player with the highest ranking hand wins all of the wagers.

U.S. Pat. No. 5,975,529, issued to de Keller, describes a poker game played on a blackjack style table with a single dealer. The player opening the betting is rotated for each game. The game is played with chips/counters of various denominations. At the start of each game all players place a bet of equal value in their respective pots. Players then place Bet 1 (the maximum and minimum value thereof being determined by the house) and each player is dealt two cards (this number may vary), face-down, and the dealer receives three cards (this number may vary) one face-up and two face-down. The three dealer's cards are community cards, referred to as the ‘flop’ and complete each player's hand. The players, at this stage know the identity of three cards and each player has the option of discarding their first or second card, or both, face down. Replacements, face-down, are received for discards. Players may at this stage, either ‘stand’ by making no further bets or ‘raise’ by wagering on Bet 2. The Bet 2 wager must be exactly equal in value to the amount wagered on Bet 1. When all wagers have been placed on Bet 2 the fourth card is revealed by the dealer. Players may again either stand at this stage or raise by wagering on Bet 3. Players are not permitted to make a third bet if they have not placed the second. The Bet 3 wager must be exactly equal in value to the amount wagered on Bet 1. When all third bets have been placed the dealer turns up the fifth card. Each player reveals his/her cards and provided they show a winning hand on the list of poker rankings hands are paid according to the total stake placed at the corresponding pay-offs/odds. The player with the highest poker hand is awarded all the Pot bets; in the event of players holding identical hands the Pot is shared. No matter how many cards constitute community cards or how many cards are dealt to each player, the players select five cards to make up their hands. There is no variation in wagering allowed, and competition includes wagers against the pot.

However, none of the cited prior art provides the same structure, gameplay, or payouts as the Hot Links game.

### SUMMARY OF THE INVENTION

The current invention is directed to a casino style game and method of playing thereof including a specific game structure, betting format, and payout structure. The game is a card game played with a unique deck of 65 cards. The 65-card deck consists of 13 cards a card which represent either a 1 or a 14 (1/14 card), and cards numbered 2 through 13. The cards are of five different colors where each 1-14 series of cards is a particular and distinct color. For example, in the preferred embodiments the cards are green, blue, purple, orange, and red. The 11 thru 1/14 card can optionally be substituted for the Jack, Queen, King and Ace cards. The Ace card can optionally be the 1/14 card.

In an alternative embodiment the game played with a unique deck of 78 cards. The deck of 78 cards contains six colors of the cards 2,3,4,5,6,7,8,9,10,11,12,13, and a 1/14 card.

In some embodiments of the invention the game is played in the following manner:

The player begins the game by placing an Ante wager. Optionally, they may also place a Bonus wager. In the preferred embodiment, the Ante and Bonus wagers have different but optionally overlapping win conditions and different but optionally overlapping payouts. In the preferred embodiment a player may not place a Bonus wager without also placing an Ante wager. In an alternative embodiment a player may place a Bonus wager without placing an Ante wager. In some embodiments, a player may place a Bonus wager on a separate/different player's hand who has placed an Ante wager but not a Bonus wager.

Any player who has placed at least an Ante wager (or at least a Bonus wager in the alternative embodiment) is dealt three cards. After the player's receive their initial three cards, the remaining cards dealt will be community cards. After the initial three cards are dealt a determination is made regarding whether the three cards meet any winning conditions. The winning conditions are as follows:

With regard to the Ante wagers, winning combinations are formed with both pairs and “links.”

A pair is two cards that have the same numerical value, for example, two cards each having the value of 5. Only for purposes of the Ante wager, in the initial three cards, any two cards, or three cards matching in value are regarded as a pair. In later cards, a pair is formed if the most recently dealt card matches in value to any of the three initial cards dealt.

A link is a collection of two or more cards that can be placed in a sequence where each card is adjacent to the previous card in value. For example, three cards with the numerical values of 4, 5, and 6 or alternately 4, 5, and 4. In the preferred embodiment the 1/14 card is considered to be adjacent to both the 2 card and the 13 card.

For example:

A seven card link is a linking of one card to a chain of six cards, in a manner which all cards connect to form a numerical sequence of cards, which is one value greater than or one value less than a connecting card. Ex. A (2) card forms a link with a (3-2-1/14-13-12-13) six card link, (2-3-2-1/14-13-12-13);

A six card link is a linking of one card to a chain of five cards, in a manner which all cards connect to form a numerical sequence of cards, which is one value greater than or one value less than a connecting card. Ex. A (10) card forms a link with a (J-Q-J-10-9) five card link, (10-11-12-11-10-9);

A five card link is a linking of one card to a chain of four cards, in a manner which all cards connect to form a numerical sequence of cards, which is one value greater than or one value less than a connecting card. Ex. A (5) card forms a link with a (6-7-8-7) four card link, (5-6-7-8-7);

A four card link is a linking of one card to a chain of three cards, in a manner which all cards connect to form a numerical sequence of cards, which is one value greater than or one value less than a connecting card. Ex. A (13) card forms a link with an (1/14-2-3) three card link, (13-1/14-2-3);

A three card link is a linking of one to a chain of two cards, in a manner which all cards connect to form a numerical sequence of cards, which is one value greater than or one value less than a connecting card. Ex. A (7) card forms a link with an (8-7) two card link, (7-8-7);

A two card link is a linking of one card to another card, in a manner which both cards connect to form a numerical sequence of cards, which is one value greater than or one value less than the connecting card. Ex. A (4) card forms a link with a (5) card, or a (3) card, (5-4), (3-4);

In the preferred embodiment, there are mixed color links and same color links. A mixed color link is a sequence of cards which are not all of the same color. A same color link is a sequence of cards which are all of the same color.

Once a link is initially established, any further links must “extend” the previous link. In the preferred embodiment to establish a new link, the new link must meet all of the following conditions:
The new link must use the most recently dealt card.
The new link must use at least one card from the previous link.
The new link must be longer in length than the previous link.
If the previous link was a mixed-color link, then the new link will be classified as a mixed-color link, because the cards are not all of the same colors.

It is not necessary that the extended mixed color link use all cards in the previous link. For example, if a player has the cards {2(blue) 2(red), 3(blue), 5(blue)}, they have a three-card link of [2(blue)-3(blue)-2(red)]. If the player is then dealt a 4(blue), then the new link will be extended to a four-card link of [2(blue)-3(blue)-4-(blue)]. Under such circumstances the sequence would be treated as a mixed color link because the 2(red) which was included in the previous link is not the same color as the cards of the four-card link.

The first Ante wager is resolved based on the first three cards dealt. If the cards form a two-card link, three-card link, or a pair, then the Ante wager wins and pays according to the payout scenario. Otherwise, the Ante wager loses. The win conditions and payouts in the preferred embodiments are provided in Table 1.

TABLE 1
Pays - Ante Wagers

| Scenario | Same-color Pay | Multi-color Pay |
|---|---|---|
| Seven-card Link | 250 to 1 | 75 to 1 |
| Six-card Link | 100 to 1 | 25 to 1 |
| Five-card Link | 50 to 1 | 20 to 1 |
| Four-card Link | 15 to 1 | 5 to 1 |
| Three-card Link | 6 to 1 | 3 to 1 |
| Two-card Link | 1 to 1 | 1 to 1 |
| Pair | N/A | 1 to 1 |

If the Ante wager wins, the player will be eligible to place additional Ante wagers, equal to the first Ante wager, and receive an additional community card each time. Likewise, if the Bonus wager wins, the player may place additional Bonus wagers, respectively. In some embodiments, the Bonus bet must be of the same amount as the Ante bet. In some embodiments, the Bonus bet must be greater than the Ante bet. In some embodiments, the Bonus bet is a fixed amount not determined by the player but rather the table (house). In some embodiments, the Ante bets and Bonus bets must remain equal to the first respective Ante bet and Bonus bet made by the player. In some embodiments, the Ante bets and Bonus bets may vary from round to round. In some of these embodiments, Ante bets and Bonus bets must increase with each additional round and in some of these embodiments, Ante bets and Bonus bets must decrease with each additional round.

In some embodiments, it is not required that the additional community card provide a hand with an increased payout to win. See example 1 which applies the payouts and win conditions of Table 1.

### EXAMPLE 1

A player is dealt a three card, same color link of 4,5,6, and choses to continue by placing an additional Ante wager. The next community card is a 4. In this scenario, the player wins the additional Ante wager for a pair, and is paid 1 to 1. Due to the player initial three cards all being the same color and the player winning the initial Ante wager for a 3 card same color link, to win again as a same color link the remaining cards must be of the same color and also form a link. Since the next community card was a (4) the player can no longer win a same color link, because for a same color link all of the players cards must be used and link, but with the remaining cards the player may win for multi-color links. If for example, if the player placed a second additional wager and the next community card dealt was a (5), the player would win with a four card multi-color link. The player can also pair their initial three cards anytime and win the Ante and be paid 1 to 1 each time. The player is paid for the highest link achieved. If a player is paid for a three card link, his next link payout must be a four card link, because the next card must link or pair with the player's previous cards.

The Bonus wager wins if any of the following conditions are met:
1. All three initial cards have the same color.
2. All three initial cards have different colors.
3. Two or more of the initial cards have the same value/pair.

If the cards are eligible for more than one type of win (e.g. 3 cards of different colors, but all of the same value/pair), then the highest paying category shall be used. If the initial cards meet none of the above conditions, the Bonus wager loses. The Bonus wager win conditions and payouts in the preferred embodiments are shown in Table 2.

TABLE 2
Pays - Bonus Wager

| Scenario | All Same Colors | All Different Colors | Same Value |
|---|---|---|---|
| Five Cards | 25 to 1 | 25 to 1 | 100 to 1 |
| Four Cards | 5 to 1 | 5 to 1 | 20 to 1 |
| Three Cards | 2 to 1 | 2 to 1 | 5 to 1 |
| Two Cards | N/A | N/A | 1 to 1 |

Although the Bonus wager has different win conditions and payouts from the Ante wager, the Bonus wager follows the same rules and procedures as the Ante wage as shown, for example in Example 1. Each time the player places one or more additional wagers, a new community card is dealt, which is used to evaluate the additional wager(s). This process may continue until one of the following conditions occurs:
1. The player wins the highest available award for the wager,
2. The player loses the wager,
3. The player decides to discontinue wagering, or
4. A maximum of five community cards are dealt.

If one wager loses and another wager wins, then the player remains eligible to place additional wagers of the type that won, but cannot place additional wagers of the losing type. For example, if a player initially places an Ante and a Bonus wager, if the Ante loses, and if the Bonus wins, the player may place an additional Bonus wager, but may not place an additional Ante wager.

The additional Bonus wagers win if any of the following conditions are met:
1. For a same-color win: The additional card matches all the previous cards in color.
2. For a different-color win: The additional card differs from all the previous cards in color.
3. For a same-value/pair win: The additional card has the same value/pair of the two or three cards of the same value/pair that won the initial Bonus wager.

For example, if the initial three cards are [5(red)-5(green)-5(blue)], then the Bonus wager would win 5 to 1 and be established as a same-value/pair category win of the (5) card, since this pays higher than three cards of different colors. If the next card were a (7), the Bonus wager would win 5 to 1 and be established as an all-different colors win, which is four cards of different colors. Only the highest applicable payout for the Bonus wager is applied.

The win conditions and payouts are not limited to those shown in tables 1 and 2. The payouts in tables 1 and 2 provide a modest mathematical advantage against the player (for the house). However, payouts may be adjusted to provide any degree of house or player advantage. Win conditions may also include, for example, by allowing additional cards of the same value to be considered a win, for example three of a kind. Win conditions may also include traditional poker hands, for example, two pair and full house; and non-traditional poker hands, for example, 3 pair.

### EXAMPLE 2

Example 2 describes an example hand of an embodiment of the game. The dealer deals three consecutive cards face down to each player that has placed at least an Ante bet of a qualifying amount (table minimum), the dealer completes all betting with each player one at a time, beginning with the player farthest to the dealer's left and moving clockwise around the table:

The dealer shall reveal each player's cards and determine whether each player has formed a link and won the Ante bet and/or the Bonus Bet:

If a player forms a two or three card link, the player is paid the highest link formed for the Ante wager in accordance with the Ante Payout Odds.

After settling the player's Ante wager, the dealer shall settle the Bonus wager;

If a player has won the Bonus wager, the dealer shall pay the winning Bonus wager in accordance with the Bonus Payout Odds.

If a player formed a two card link, the card that failed to link will be removed, unless:
(a) The player wins the Bonus Bet;
(b) When this occurs, the card that failed to link will be placed aside of the cards that linked, and the card will be used for the Bonus Bet only.

If a player's cards fail to form a link, the dealer shall immediately collect the player's:
(a) Ante Wager and place it in the table inventory container;
(b) If the player wins the Bonus Bet, the player's cards shall be left on the table until all wagers are resolved.
(c) The player has the option to stop (ending the game and taking his winnings) or to continue. If the player decides to continue, the player must wager the same amount of the Ante in the Ante box, and if the player is playing the Bonus Bet, the same amount of the Bonus Bet must be wagered for the Bonus Bet.

If a player continues to win the wagered bet, the dealer will deal the remaining cards face up one at a time, to each player that has placed a wager equal to the amount of the Ante bet, beginning with the player farthest to the dealer's left and moving clockwise around the table. The dealer will complete the betting process with each player one at a time until, the player has won all bets wagered forming seven links, received a maximum of eight cards, lost all bets wagered, or the player does not place a wager.

The current invention may be played live (in person) or as a video game. In the preferred embodiments, the live game is played using a customized game board. In the preferred embodiments, the video game is played using a computer with a display.

In the preferred embodiments of the live game, the video game, or both specific locations are provided for certain elements of the game, for example:

The logo/name of the game;

The dealer chip tray;

A chip slot for tips the players give to the dealer;

A table(s) or display(s) of the Ante and Bonus win conditions and payouts. This information may be presented together, for example, in a single table or display or separately, for example, in multiple tables or displays being positioned independently of one another or with a visually apparent positional relationship to each other;

A location(s) for the players Ante wager(s) and Bonus wager(s). This information may be presented together, for example, as a single designated space or separately, for example, as multiple designated spaces for each bet of the same kind or as a designated space for each and every bet where the spaces are positioned independently of one another or with a visually apparent positional relationship to each other. In the preferred embodiments, the definition of each space is indicated visual, for example, by text stating what each space is designated as; by a representative color or shape or combination thereof of each space; or any combination of text, color and shape;

Defined spaces for each player(s) cards;

Defined spaces for the placement of the community cards.

In some embodiments of the casino game, the casino game comprises:

a deck of cards wherein said deck of cards comprises
at least two series of cards, each having values from 1 to n wherein n is any whole number, and
wherein each series of cards consists of cards having the same color and wherein each series has a distinct color;

a playing surface wherein the playing surface comprises distinct designated areas for player cards, community cards, and an Ante wager.

In some embodiments of the casino game, the playing surface additionally comprises a distinct designated area for a Bonus wager.

In some embodiments of the casino game, the playing surface additionally comprises at least one table showing win conditions and payouts for the Ante wager and the Bonus wager.

In some embodiments of the casino game, the playing surface comprises a table showing win conditions and payouts for the Ante wager and a separate table showing win conditions and payouts for the Bonus wager.

In some embodiments of the casino game, the playing surface additionally comprises a dealer's chip tray.

In some embodiments of the casino game, the playing surface additionally comprises a chip tip slot.

In some embodiments of the casino game, the playing surface additionally comprises a logo, game title, or game identifying information.

In some embodiments of the casino game, the distinct designated areas for the community cards consists of five separately defined areas.

In some embodiments of the casino game, the distinct designated areas for the player cards is a single defined area for each player and wherein the total number of distinct designated areas for the player cards indicates the maximum number of players which playing surface can accommodate.

In some embodiments of the casino game, the distinct designated areas for the community cards is positioned at the general center of the playing surface, the distinct designated areas for the player cards is positioned around the exterior of the playing surface, and the distinct designated areas for the Ante wager and Bonus wager are positioned directly above each distinct designated areas for the player cards and oriented toward the distinct designated areas for the community cards, and wherein the designated areas for the Ante wager and Bonus wager are positioned adjacent to each other.

In some embodiments of the casino game, the deck includes cards with a value of 1-14.

Some embodiments of the casino game are a method for playing a casino game comprising:

dealing three cards to at least one player who has placed an Ante wager from a deck comprising:
at least two series of cards, each having values from 1 to n wherein n is any whole number, and
wherein each series of cards consists of cards having the same color and wherein each series has a distinct color;

determining whether the three cards meet any win conditions;

resolving a first round of the game by paying the player in accordance with greatest payout odds matching a win condition satisfied by the three cards or removing the players Ante wager if no win conditions are satisfied;

conducting additional rounds of the game upon satisfaction of addition round conditions, said additional rounds comprising:

dealing at least one community card,

determining whether the community card in combination with the three cards dealt to a player meet any win conditions of the Ante wager,

resolving the additional round by paying the player in accordance to the greatest payout odds out matching a win condition met by the combination of community and player cards or removing all player Ante wagers if no win conditions are met, wherein the addition round conditions comprise:

a. at least one player has placed an additional Ante wager for every additional community card dealt,

b. the cards of the at least one player who has placed the additional Ante wager have never failed to satisfy at least one win condition in any round of the game.

A round of the game is defined is defined the making of a wager to resolution of that wager, for example, an Ante wager is made, a determination regarding whether is wins or not is made, and the appropriate action (pay or take money from the player) is made. A single round can include the making and resolution of both an Ante wager and a Bonus wager but not multiple wagers of the same kind.

Some embodiments of the casino game method additionally comprising determining whether the cards for a player meet any win conditions a Bonus wager placed by the player, and

resolving a first round of the game by paying the player in accordance with greatest payout odds matching a win condition satisfied by the three cards or removing the players Bonus wager if no win conditions are satisfied

conducting additional rounds of the game upon satisfaction of addition round conditions, said additional rounds comprising:

dealing at least one community card,

determining whether the community card in combination with the three cards dealt to a player meet any win conditions of the Bonus wager,

resolving the additional round by paying the player in accordance to the greatest payout odds out matching a win condition met by the combination of community and player cards or removing all player Bonus wagers if no win conditions are met, wherein the addition round conditions comprise:

a. at least one player has placed an additional Ante wager for every additional community card dealt,

b. the cards of the at least one player who has placed the additional Ante wager have never failed to satisfy at least one Ante wager win condition in any round of the game, and

c. the at least one player who satisfies the conditions of a and b has additionally placed an additional Bonus wager for every additional community card dealt and wherein the cards of the at least one player who has placed the additional Bonus wager have never failed to satisfy at least one Bonus wager win condition in any round of the game.

In some embodiments of the casino game method, the win conditions for the Ante wager comprise:

a Pair, a Two-card Link wherein all the cards in the link have the same color, a Three-card Link wherein all the cards in the link have the same color, a Four-card Link wherein all the cards in the link have the same color, a Five-card Link wherein all the cards in the link have the same color, a Six-card Link wherein all the cards in the link have the same color, a Seven-card Link wherein all the cards in the link have the same color, a Two-card Link wherein at least two cards in the link have a different color, a Three-card Link wherein at least two cards in the link have a different color, a Four-card Link wherein at least two cards in the link have a different color, a Five-card Link wherein at least two cards in the link have a different color, a Six-card Link wherein at least two cards in the link have a different color, and a Seven-card Link wherein at least two cards in the link have a different color.

In some embodiments of the casino game method, the payout odds for the Ante wager win conditions comprise:
1:1 for a Pair, 1:1 for a Two-card Link wherein all the cards in the link have the same color, 6:1 for a Three-card Link wherein all the cards in the link have the same color, a 15:1 for Four-card Link wherein all the cards in the link have the same color, 50:1 for a Five-card Link wherein all the cards in the link have the same color, 100:1 for a Six-card Link wherein all the cards in the link have the same color, 250:1 for a Seven-card Link wherein all the cards in the link have the same color, 1:1 for a Two-card Link wherein at least two cards in the link have a different color, 3:1 for a Three-card Link wherein at least two cards in the link have a different color, 5:1 for a Four-card Link wherein at least two cards in the link have a different color, 20:1 for a Five-card Link wherein at least two cards in the link have a different color, 25:1 for a Six-card Link wherein at least two cards in the link have a different color, and 75:1 for a Seven-card Link wherein at least two cards in the link have a different color.

In some embodiments of the casino game method, the win conditions for the Bonus wager comprise:
Three cards all having the same color, Four cards all having the same color, Five cards all having the same color, Three cards all having different colors, Four cards all having different colors, Five cards all having different colors, Two cards all having the same value, Three cards all having the same value, Four cards all having the same value, Five cards all having the same value.

In some embodiments of the casino game method, the payout odds for the Bonus wager win conditions comprise:
2:1 for Three cards all having the same color, 5:1 for Four cards all having the same color, 25:1 for Five cards all having the same color, 2:1 for Three cards all having different colors, 5:1 for Four cards all having different colors, 25:1 for Five cards all having different colors, 1:1 for Two cards all having the same value, 5:1 for Three cards all having the same value, 20:1 for Four cards all having the same value, 100:1 for Five cards all having the same value.

In some embodiments of the casino game method, the deck includes cards with a value of 1-14.

In some embodiments of the casino game method, the game is played on a playing surface.

In some embodiments of the casino game method, the game is played on an electronic device.

### BRIEF DESCRIPTION OF THE DRAWINGS:

FIG. 1 depicts a table layout used for playing the game.

FIG. 2 is a display used for playing the game in an electronic medium.

FIG. 3 is an example display used for playing the game in an electronic medium.

FIG. 4 is alternative display configuration for playing the game in an electronic medium or at a live table showing a close up view of the player cards section of the display.

FIG. 5 is alternative display configuration for playing the game in an electronic medium or at a live table showing a close up view of the player cards section of the display.

FIG. 6 shows and example of the front and back of cards suitable for use in the embodiments of the invention.

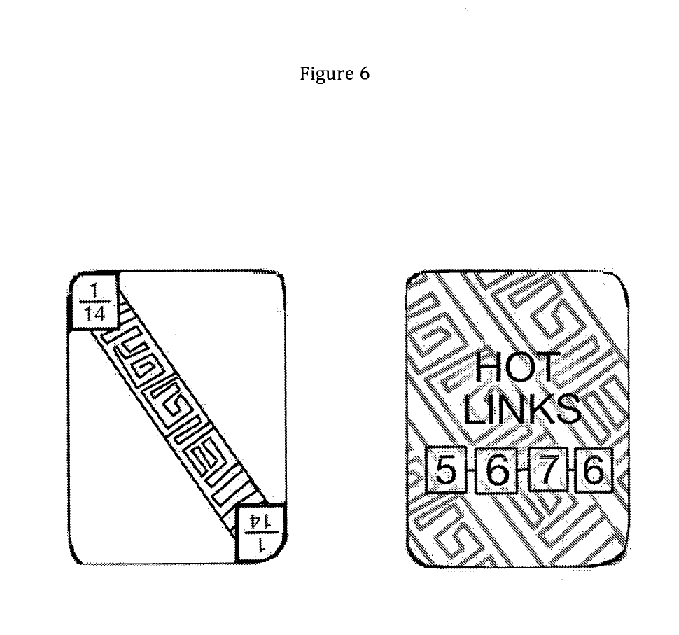

FIG. 7 shows and example of the front and back of cards suitable for use in the embodiments of the invention.

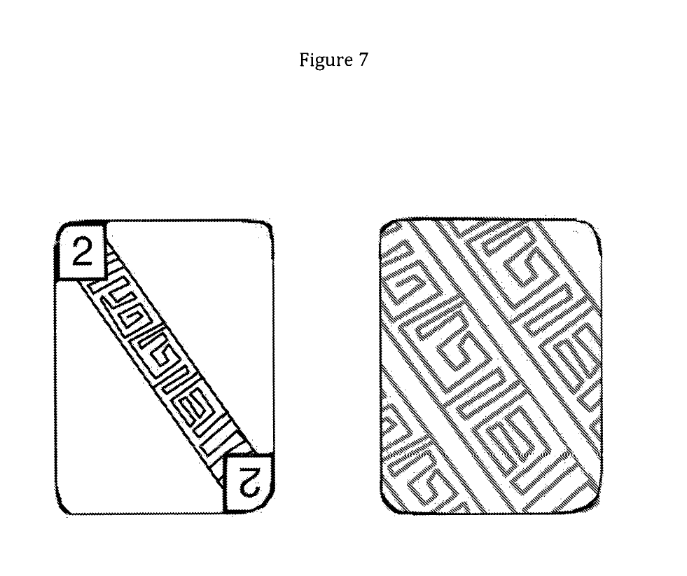

### DETAILED DESCRIPTION OF THE DRAWINGS

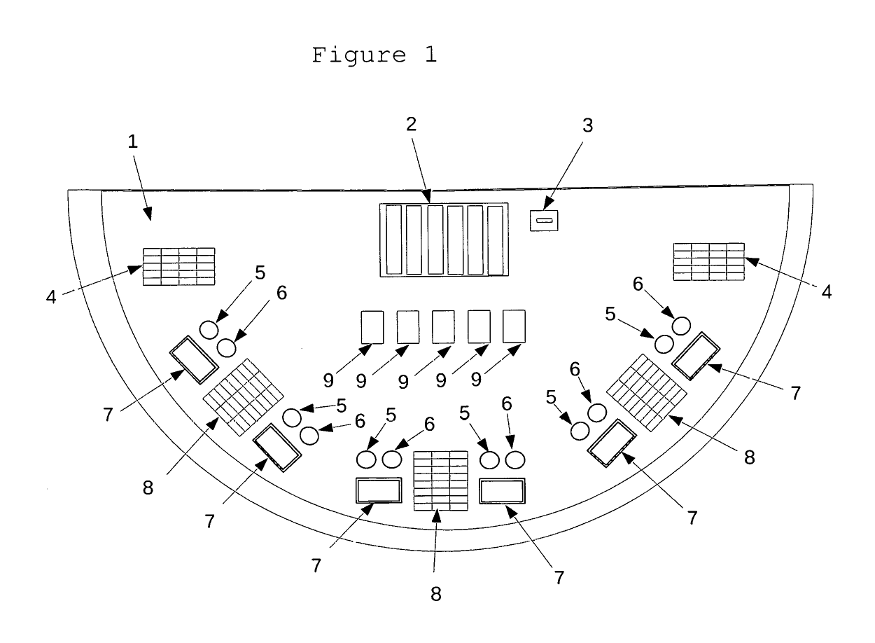

FIG. 1 depicts a table layout used for playing the game. This could be used for playing a live game or alternatively it could be displayed on an electronic device. The logo, game title, and/or game identifying information (1) is positioned at the top center portion of the board from the players perspective, i.e., closest to where the dealer is positioned. In the preferred embodiment the word Hot Links and the representation of the cards 5-6-7-6, underneath the word is displayed.

The dealer's chip tray (2) is positioned where the facility which operates the game stores its chips, i.e., the house. The displayed option in the figure places the chip tray (2) in the center of the table opposite where the players are positioned. The value of the chips is determined by the facility which operates the game. The chips can have any value, for example, $1, $5, $10, $25, $100, or $500. The purpose of the chip tray is to convert the player's cash into money chips which are of the same value of the player's cash money. These chips are used for wagers offered by the players, and the chip tray (2) is the location where the chips are removed from to pay the player's winning wagers, and the location to store the chips from the players that lose wagers.

The chip tip slot (3) is used for dealers to store the chips that are given to the dealer in the form of a tip from the players. The chip tip slot (3) may be positioned anywhere. In the preferred embodiments, it is positioned within reach of the dealer and/or closer to the dealer than to the players.

The Bonus Payout Table (4) identifies the scenarios/win conditions of the player's cards to which the players win the Bonus Wager and the payout odds for the player's Bonus wagers. In the preferred embodiment, the top of this table is positioned in an area adjacent to the dealer's chip tray (2) and optionally the chip tip slot (3). In the preferred embodiment, the Bonus Payout Table (4) includes four headings at the top of the table, for example, Scenario, All Same Colors, All Different Colors, and Same Value. The Scenario column identifies the number of cards which the player is utilizing to qualify for a Bonus payout. The columns of All Same Colors, All Different Colors, and Same Value identify the arrangement of cards the player must have to win the Bonus Wager. The win conditions and payout odds for the Bonus bet are displayed in the Bonus Payout Table (4). In the preferred embodiments the Scenario, All Same Colors, All Different Colors, and Same Value are positioned from left to right in the Bonus Payout Table (4).

The player's Ante wager spot (5) is a visually defined location where a player must place chips in to place an Ante wager which is required to play the game. The Ante wager must be placed in the Ante wager spot (5) prior to the player receiving their initial three cards and before the revealing any community card. The player may place additional Ante wagers only if the player wins the previous Ante wager. The Ante wager is won if the player's initial three cards form a pair or a link, and additional Ante wagers are won if the community card revealed pair with the player's cards, or link with the player's cards and community cards.

The player's Bonus wager spot (6) is a visually defined location where a player must place chips in to place a Bonus wager. In the preferred embodiments, this is an option bet which is not mandatory to player the game. In the preferred embodiments, the Bonus wager amount must be equal to or less than the Ante wager. If the player decides to place the optional Bonus wager, the Bonus wager must be placed in the Bonus wager spot (6) prior to receiving the player's three cards or the revealing of a community card. The player may place additional Bonus wagers only if the player wins the previous Bonus wager. The Bonus wager is won if the player's initial three cards form a pair, three cards of the same color or three cards each of different colors. Additional Bonus wagers are won if the community card revealed pair with one of the player's cards, is the same color of the cards that are all the same color, or is of a different color than the previous cards that are all of different colors.

The player's cards spot (7) is a visually defined location where the dealer places the player's cards. That is, in the preferred embodiments, the three cards dealt to the player after an Ante wager is placed in the Ante wager spot (5) are dealt to the player's cards spot (7). In the preferred embodiment, the player's cards spot (7) is located close to the where a player is sitting at the table.

The table includes an Ante Payout Table (8). The Ante Payout Table (8) identifies the scenarios of the player's cards to which the players win the Ante Wager, i.e., the win conditions and payouts for Ante wagers. The Ante Payout Table (8) of the preferred embodiment includes three headings at the top of the table including Scenario, Same Color-Pay, and Multi-Color Pay. The Scenario column identifies the number of cards which the player is utilizing to qualify for an Ante payout. The columns identify the arrangement of cards the player must have to win the Ante Wager. For each number of cards the players have, and for the arrangement of cards the players have, the player may win the wager and be paid in accordance with the payout odds posted in the Ante Payout Table. In the preferred embodiments the Scenario, Same Color-Pay, and Multi-Color Pay are positioned from left to right in the Ante Payout Table (8).

The table of FIG. 1 also includes a community cards spot (9). The community cards spot (9) is a visually defined location where the dealer places the community cards. The community cards are cards that each player combines with the cards that are dealt to the player to compete against the Ante and Bonus wagers payout tables. These cards are revealed one at a time after the players place an additional Ante and/or Bonus wager. In the preferred embodiment, the community cards spot (9) is located at or near the center of the table i.e., at an equal distance to all player table positions.

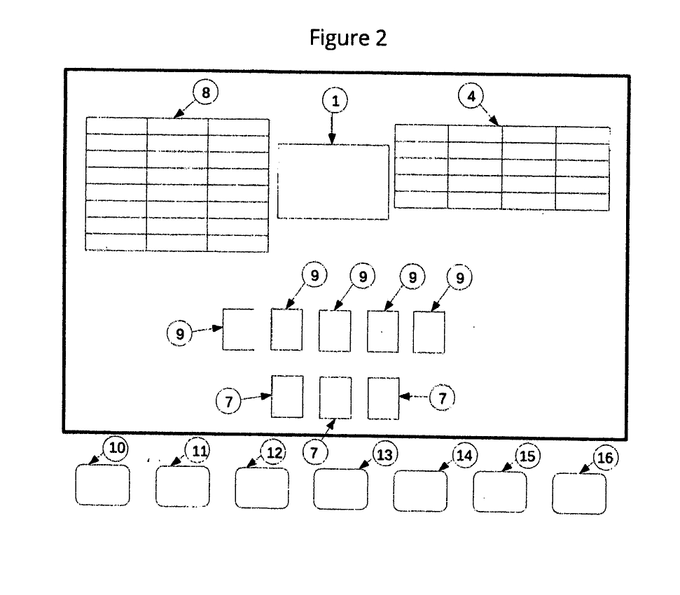

FIG. 2 is a display used for playing the game in an electronic medium, i.e., on an electronic device.

The display of FIG. 2 includes a logo, game title, and/or game identifying information (1), Bonus Payout Table (4), player's cards spot (7), Ante Payout Table (8), and community cards spot (9) as defined above.

The display of FIG. 2 also includes a credits spot (10). The credits spot (10) shows the balance of credits the player has to wager with. The display also includes a cash out button (11). The cash out button (11) visually indicates a location on the display which can be used by the player to withdraw credits from the game.

FIG. 2 also includes a total bet display (12). This shows the combined total of the current bet. The deal button (13) visually indicates a location on the display which allows the player to begin the deal after the player has placed their bet. The fold button (14) visually indicates a location on the display which allows the player to quit the current hand.

FIG. 2 also includes an Ante bet button (15) which visually indicates a location on the display which allows the player to place a wager for the Ante bet. The Ante wager must be placed prior to beginning play. The player may place additional Ante wagers only if the player wins the previous Ante wager. The Ante wager is won if the player's initial three cards form a pair or a link, additional Ante wagers are won if the community card revealed pair with the player's cards, or link with the player's cards and community cards.

FIG. 2 also includes a Bonus bet button (16) which visually indicates a location on the display which allows the player to place a wager for the Bonus bet. In the preferred embodiment, the Bonus wager amount must be equal to or less than the Ante wager. If the player decides to place the optional Bonus wager, the Bonus wager must be placed prior to beginning play. The player may place additional Bonus wagers only if the player wins the previous Bonus wager. The Bonus wager is won if the player's initial three cards form a pair, three cards of the same color or three cards each of different colors. Additional Bonus wagers are won if the community card revealed pair with one of the player's cards, is the same color of the cards that are all the same color, or is of a different color than the previous cards that are all of different colors.

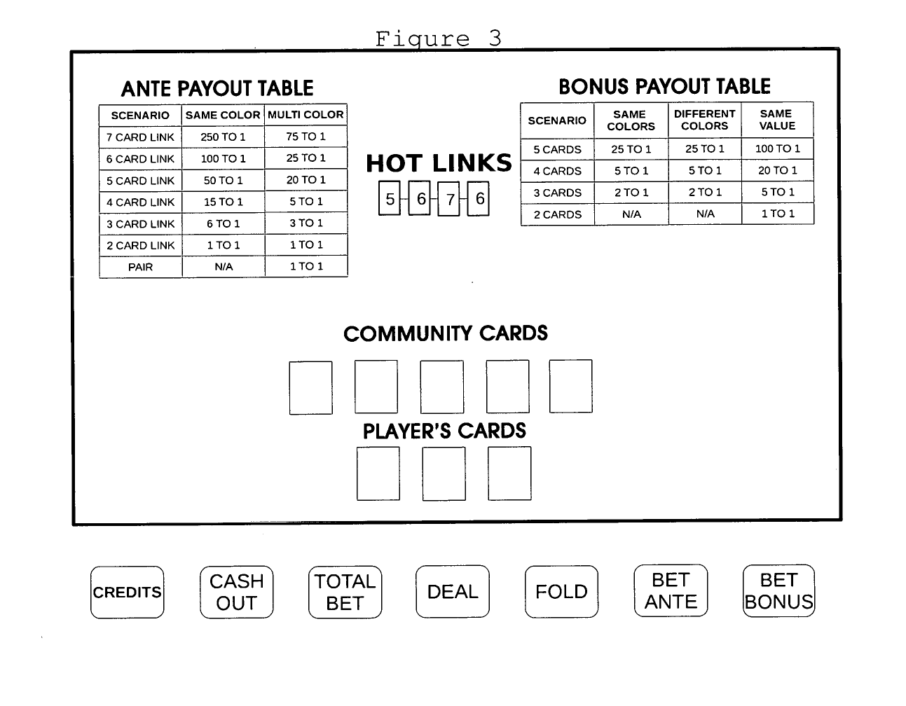

FIG. 3 is an example display used for playing the game in an electronic medium showing a logo, game title, and/or game identifying information (1), Bonus Payout Table (4), player's cards spot (7), Ante Payout Table (8), community cards spot (9), a credits spot (10), a cash out button (11), a total bet display (12), a deal button (13), a fold button (14), a Ante bet button (15) and a Bonus bet button (16) as defined above.

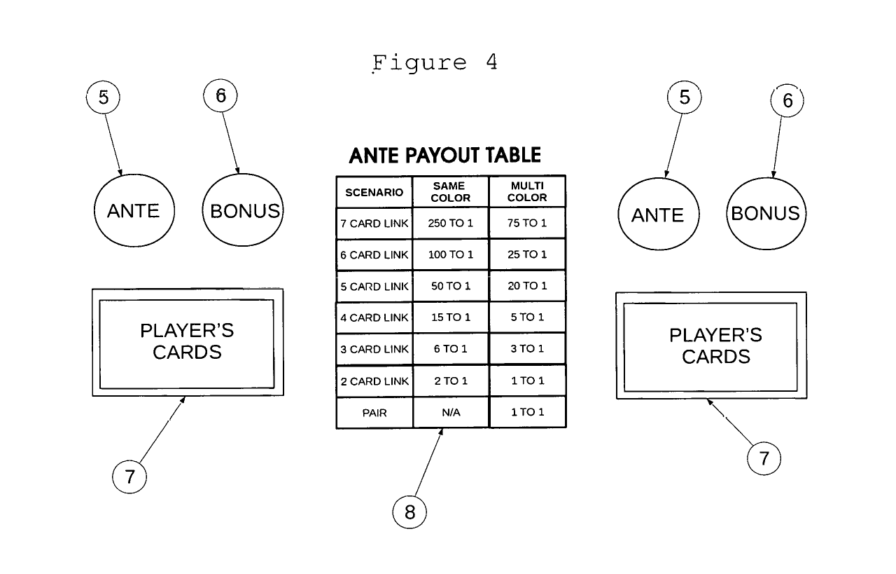

FIG. 4 is alternative display configuration for playing the game in an electronic medium or at a live table showing a close up view of the player cards section of the display. FIG. 4 includes Ante wager spot (5), Bonus wager spot (6), player's cards spot (7), and Ante Payout Table (8).

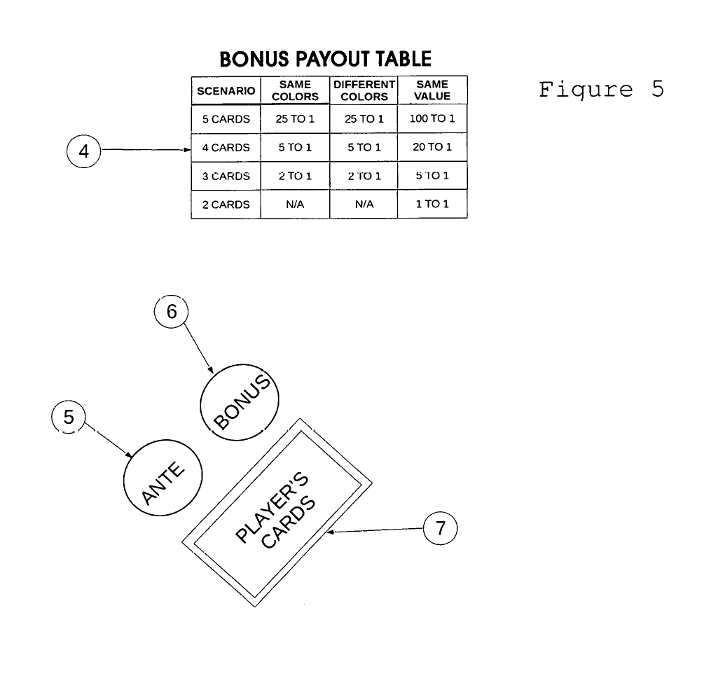

FIG. 5 is alternative display configuration for playing the game in an electronic medium or at a live table showing a close up view of the player cards section of the display. FIG. 5 includes Bonus Payout Table (4), Ante wager spot (5), Bonus wager spot (6), and player's cards spot (7).

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be used with similar success by substituting the generically or specifically described alternative win conditions and payouts or by alternatively rearranging the positioning of the structures shown in the figures as needed.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A casino game comprising:
a deck of cards wherein said deck of cards comprises
at least two series of cards, each having values from 1 to n wherein n is any whole number, and
wherein each series of cards consists of cards having the same color and wherein each series has a distinct color;
a playing surface which comprises distinct designated areas for player cards, community cards, and an Ante wager.

2. The casino game of claim 1, wherein the playing surface additionally comprises a distinct designated area for a Bonus wager.

3. The casino game of claim 2, wherein the playing surface additionally comprises at least one table showing win conditions and payouts for the Ante wager and the Bonus wager.

4. The casino game of claim 3, wherein the playing surface comprises a table showing win conditions and payouts for the Ante wager and a separate table showing win conditions and payouts for the Bonus wager.

5. The casino game of claim 4, wherein the playing surface additionally comprises a dealer's chip tray.

6. The casino game of claim 5, wherein the playing surface additionally comprises a chip tip slot.

7. The casino game of claim 6, wherein the playing surface additionally comprises a logo, game title, or game identifying information.

8. The casino game of claim 1, wherein the distinct designated areas for the community cards consists of five separately defined areas.

9. The casino game of claim 8, wherein the distinct designated areas for the player cards is a single defined area for each player and wherein the total number of distinct designated areas for the player cards indicates the maximum number of players which playing surface can accommodate.

10. The casino game of claim 6, wherein the distinct designated areas for the community cards is positioned at the general center of the playing surface, the distinct designated areas for the player cards is positioned around the exterior of the playing surface, and the distinct designated areas for the Ante wager and Bonus wager are positioned directly between each distinct designated areas for the player cards and the distinct designated areas for the community cards, and wherein the designated areas for the Ante wager and Bonus wager are positioned adjacent to each other.

11. The casino game of claim 1, wherein n equals 14.

12. A method for playing a casino game comprising:
dealing three cards to each player who has placed an Ante wager from a deck comprising:
at least two series of cards, each having values from 1 to n wherein n is any whole number, and
wherein each series of cards consists of cards having the same color and wherein each series has a distinct color;
determining whether the three cards dealt to each player meet any win conditions for the Ante wager;
resolving a first round of the game by
a) paying each player with a Ante wager win condition in accordance with greatest payout odds matching the Ante wager win condition satisfied by the three cards, and
b) removing each Ante wager where the three cards fail to satisfy any win condition of the Ante wager;
conducting additional rounds of the game upon satisfaction of addition round conditions, said additional rounds comprising:
dealing at least one community card,
determining whether the community card in combination with the three cards previously dealt to a player meet any win conditions of the Ante wager,
resolving the additional round by
a) paying each player with cards satisfying a Ante wager win condition in accordance with greatest payout odds matching a satisfied Ante wager win condition of the combination of community and player cards, and
b) removing all Ante wagers of each player whose cards fail to satisfy any win condition of the Ante wager;
wherein the additional round conditions comprise:
a) at least one player has placed an additional Ante wager for every additional community card dealt,
b) the cards of the at least one player who has placed the additional Ante wager have never failed to satisfy at least one win condition in any round of the game.

13. The method for playing a casino game of claim 12 additionally comprising
determining whether the cards for each player who has placed a Bonus wager meet any win conditions of a Bonus wager, and
resolving a first round of the game by
a) paying each player whose cards satisfy a Bonus wager win condition in accordance with greatest payout odds matching the Bonus wager win condition satisfied by the three cards, and
b) removing each Bonus wager where the three cards fail to satisfy any win condition of the Ante wager;
conducting additional rounds of the game upon satisfaction of addition round conditions, said additional rounds comprising:
dealing at least one community card,
determining whether the community card in combination with the three cards previously dealt to a player meet any win conditions of the Bonus wager,
resolving the additional round by
a) paying each player with cards satisfying a Bonus wager win condition in accordance with greatest payout odds matching a satisfied Bonus wager win condition of the combination of community and player cards, and
b) removing all Bonus wagers of each player whose cards fail to satisfy any Bonus wager win conditions;
wherein the addition round conditions comprise:
a) at least one player has placed an additional Bonus wager for every additional community card dealt,
b) the cards of the at least one player who has placed the additional Bonus wager have never failed to satisfy at least one Bonus wager win condition in any round of the game.

14. The method of claim 12 wherein the win conditions for the Ante wager comprise:
a Pair, a Two-card Link wherein all the cards in the link have the same color, a Three-card Link wherein all the cards in the link have the same color, a Four-card Link wherein all the cards in the link have the same color, a Five-card Link wherein all the cards in the link have the same color, a Six-card Link wherein all the cards in the link have the same color, a Seven-card Link wherein all the cards in the link have the same color, a Two-card Link wherein at least two cards in the link have a different color, a Three-card Link wherein at least two cards in the link have a different color, a Four-card Link wherein at least two cards in the link have a different color, a Five-card Link wherein at least two cards in the link have a different color, a Six-card Link wherein at least two cards in the link have a different color, and a Seven-card Link wherein at least two cards in the link have a different color.

15. The method of claim 14 wherein the payout odds for the Ante wager win conditions comprise:
1:1 for a Pair, 1:1 for a Two-card Link wherein all the cards in the link have the same color, 6:1 for a Three-card Link wherein all the cards in the link have the same color, a 15:1 for Four-card Link wherein all the cards in the link have the same color, 50:1 for a Five-card Link wherein all the cards in the link have the same color, 100:1 for a Six-card Link wherein all the cards in the link have the same color, 250:1 for a Seven-card Link wherein all the cards in the link have the same color, 1:1 for a Two-card Link wherein at least two cards in the link have a different color, 3:1 for a Three-card Link wherein at least two cards in the link have a different color, 5:1 for a Four-card Link wherein at least two cards in the link have a different color, 20:1 for a Five-card Link wherein at least two cards in the link have a different color, 25:1 for a Six-card Link wherein at least two cards in the link have a different color, and 75:1 for a Seven-card Link wherein at least two cards in the link have a different color.

16. The method of claim 13 wherein the win conditions for the Bonus wager comprise:
Three cards all having the same color, Four cards all having the same color, Five cards all having the same color, Three cards all having different colors, Four cards all having different colors, Five cards all having different colors, Two cards all having the same value, Three cards all having the same value, Four cards all having the same value, Five cards all having the same value.

17. The method of claim 16 wherein the payout odds for the Bonus wager win conditions comprise:
2:1 for Three cards all having the same color, 5:1 for Four cards all having the same color, 25:1 for Five cards all having the same color, 2:1 for Three cards all having different colors, 5:1 for Four cards all having different colors, 25:1 for Five cards all having different colors, 1:1 for Two cards all having the same value, 5:1 for Three cards all having the same value, 20:1 for Four cards all having the same value, 100:1 for Five cards all having the same value.

18. The casino game of claim 12, wherein n equals 14.

19. The casino game of claim 12, wherein the game is played on a playing surface or an electronic device.

20. The casino game of claim 12, wherein the game deals a maximum of five community cards over a maximum of 5 additional rounds.
